(19) United States
(12) Patent Application Publication
(10) Pub. No.: US 2023/0188764 A1
(43) Pub. Date: Jun. 15, 2023

(54) PREDICTIVE PER-TITLE ADAPTIVE BITRATE ENCODING

(71) Applicants: AT&T Intellectual Property I, L.P., Atlanta, GA (US); AT&T Communications Svcs India Pvt. Ltd, Kamataka (IN)

(72) Inventors: Peshala Pahalawatta, Burbank, CA (US); Lucian Jiang-Wei, Los Angeles, CA (US); Sudesh Chandel, Gachibowli Hyderabad (IN)

(21) Appl. No.: 17/551,734

(22) Filed: Dec. 15, 2021

(51) Int. Cl. H04N 21/234; H04N 21/25; H04N 19/40

(52) U.S. Cl. CPC H04N 21/23418; H04N 21/251; H04N 19/40

(57) ABSTRACT

A processing system may identify at least one feature set of a first video program, the at least one feature set including a complexity factor, obtain predicted visual qualities for candidate bitrate and resolution combinations of the first video program by applying the at least one feature set to a prediction model that is trained to output the predicted visual qualities for the candidate bitrate and resolution combinations of the first video program in accordance with the at least one feature set, select a bitrate and resolution combination for at least one variant of the first video program in accordance with the predicted visual qualities for the candidate bitrate and resolution combinations of the first video program, and transcode the at least one variant of the first video program in accordance with the bitrate and resolution combination that is selected for the at least one variant.

The present disclosure relates generally to adaptive video streaming, and more particularly to methods, non-transitory computer-readable media, and apparatuses for transcoding variants of a video program in accordance with bitrate and resolution combinations selected for the variants based on predicted visual qualities for candidate bitrate and resolution combinations of at least a portion of the video program.

### BACKGROUND

Streaming videos over cellular networks is challenging due to highly dynamic network conditions. While adaptive bitrate (ABR) video streaming strategies focus on maximizing the QoE, opportunities to reduce the associated data usage may be overlooked. Since mobile data is a relatively scarce resource, some video and network providers offer options for users to exercise control over the amount of data consumed by video streaming. However existing data saving practices for ABR videos may lead to highly variable video quality delivery and do not make the most effective use of network data.

### SUMMARY

In one example, the present disclosure describes a method, computer-readable medium, and apparatus for transcoding variants of a video program in accordance with bitrate and resolution combinations selected for the variants based on predicted visual qualities for candidate bitrate and resolution combinations of at least a portion of the video program. For instance, a processing system including at least one processor may identify at least one feature set of at least a portion of a first video program, the at least one feature set including a complexity factor. The processing system may also obtain predicted visual qualities for candidate bitrate and resolution combinations of the at least the portion of the first video program by applying the at least one feature set to a prediction model that is trained to output the predicted visual qualities for the candidate bitrate and resolution combinations of the at least the portion of the first video program in accordance with the at least one feature set. The processing system may then select at least one bitrate and resolution combination for at least one variant of the at least the portion of the first video program in accordance with the predicted visual qualities for the candidate bitrate and resolution combinations of the at least the portion of the first video program and transcode the at least one variant of the first video program in accordance with the at least one bitrate and resolution combination that is selected for the at least one variant.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates an example process for generating training data for training a prediction model in accordance with the present disclosure;

FIG. 3 illustrates an example process of predicting visual qualities of tracks/variants of a source video program in accordance with a trained prediction model from which a per-title quality ladder and per-chunk target bitrates for variant chunks may be selected;

FIG. 4 illustrates a flowchart of an example method for transcoding variants of a video program in accordance with bitrate and resolution combinations selected for the variants based on predicted visual qualities for candidate bitrate and resolution combinations of at least a portion of the video program; and

FIG. 5 illustrates a high level block diagram of a computing device or system specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure describe methods, computer-readable media, and apparatuses for transcoding variants of a video program in accordance with bitrate and resolution combinations selected for the variants based on predicted visual qualities for candidate bitrate and resolution combinations of at least a portion of the video program. Video delivery technology has shifted from legacy protocols, such as Real Time Messaging Protocol (RTMP) and Real Time Streaming Protocol (RTSP) to Hypertext Transfer Protocol (HTTP)-based, adaptive streaming protocols, such as Moving Picture Experts Group (MPEG) Dynamic Adaptive Streaming over HTTP (DASH). A common feature of HTTP-based adaptive streaming protocols is the availability of video in multiple chunks associated with each time block of a video and having different encoding bitrates, with the chunks linked together by a manifest file, or “index file” (also referred to as a “media presentation description” (MPD) in DASH) that defines all of the variants/tracks (e.g., respective sets of segments, each set at a different bitrate/encoding level) of the video.

In one example, a video chunk (broadly a “chunk”) may comprise a sequence of video and/or audio frames for a time block of a video that is encoded at a particular bitrate (e.g., a target bitrate, or “encoding level”). In one example, a chunk may comprise one or more segments, e.g., comprising 2-10 seconds of video content, for instance. In one example, a chunk may include 30 seconds of video content, 1 minute of video content, 5 minutes of video content, etc. In one example, a chunk may comprise a shot or a scene of the video. In one example, a start or end of a chunk may not necessarily be a start or end of a segment. For instance, a chunk boundary may comprise any frame, or an end of a group of pictures (GOP). In one example, each segment of an adaptive bitrate video may be stored as an individual data file separate from other segments. In such an example, the segment may be obtained by a requesting device, such as a player device, via a uniform resource locator (URL) identifying a file containing the segment. In another example, a segment may be stored and/or made available as a portion of a file which may contain multiple segments (e.g., for an entire chunk, such as for an entire shot or scene) or even an entire variant/track. In this case, the segment may be referred to as a “fragment.” In addition, such a segment (e.g., a fragment) may be obtained via a URL identifying the file containing the segment and a byte range, timestamp, index, sequence number, or the like to distinguish the segment from other segment in the same file. The URL(s) and other information that may be used by a player device to request and obtain chunk segments of an adaptive bitrate video may be stored in a manifest file which may be obtained by the player device in advance of a streaming session.

For a time block of an adaptive bitrate video, there may be multiple associated chunks (or segments) at respective bitrates. In particular, each of these associated chunks (or segments) may be of a respective variant for the video. In addition, each variant may comprise a set of chunks (or segments) encoded at a same bitrate (e.g., a target bitrate) and covering successive time blocks so as to constitute a complete copy of the video at the (target) bitrate for that variant. In one example, the time blocks may have a duration that is defined in advance in accordance with an adaptive bitrate protocol and/or set according to a preference of a video player vendor, a video service provider, a network operator, a video creator, a transcoder vendor, and so forth. In one example, chunks (or segments) may be associated with particular time blocks of a video via sequence numbers, index numbers/indices, or the like which indicate a relative (temporal) order of the time blocks within the overall video. For instance, time block indicators for each available chunk (or segment) may be included in the manifest file so that a player device may determine which chunks may be requested for each time block and so that the player device may determine which chunk(s) (or segment(s)) to request next (e.g., for successive time blocks).

A variety of factors may affect users' quality of experience for video streaming. These include video stalls, startup delay, and poor video/audio quality. Adaptive bitrate (ABR) streaming over HTTP is widely adopted since it offers significant advantages in terms of both user-perceived quality and resource utilization for content and network service providers. Unlike video downloads that must complete fully before playback can begin, streaming video starts playing within seconds. With ABR-based streaming, each video is encoded at a number of different rates (called variants) and stored on servers as separate files. A video client running on a mobile device, home television, game console, web browser, etc. may choose which video rate to stream by monitoring network conditions and estimating the available network capacity.

The function of the ABR algorithm is to select ABR variants (called representations in DASH) in real time to maximize video quality and minimize re-buffering events. For example, a video client maintains a media cache (also referred to as a “buffer” or “video buffer”), by pre-fetching video segments; then playback occurs from the media cache. For each time block of a video-on-demand (VoD) program/live channel, the video client selects which variant (segment) of that time block to download into the media cache. Higher quality segments for a given time block are larger in size (data volume) and take longer to download than lower quality chunks. In general, the goal is to download as high quality a segment as possible each time while keeping the buffer from going empty.

One approach to variant or segment selection is channel capacity estimation, which uses segment download time as an estimate of available channel bitrate. The video client selects a segment of a variant having a bitrate/encoding level that most closely matches the channel bitrate without exceeding it. In an environment where throughput is highly variable, such as a mobile network, accurate estimation of future channel capacity is challenging.

Another approach uses a current buffer level (e.g., a measure of an amount of time of video stored in the buffer to be played out), instead of estimated channel bandwidth, to select the bitrate/encoding level of the next segment. As with capacity estimation, the objective is to balance the flow of data into the buffer with the outflow, i.e., to keep the buffer from going empty or overflowing. Unlike with channel capacity estimation, for buffer occupancy-based approach, the actual buffer level is used to select the next segment, e.g., with a linear, or approximately linear, mapping function. The higher the current buffer level, the higher the bitrate selected for the next segment for the next time block, and vice versa: the lower the buffer level, the lower the variant bitrate selected. This ensures conservative behavior, e.g., selecting minimum quality/chunk size, when the buffer is low, i.e., filling the buffer more quickly using a chunk of a lower variant, and aggressive behavior, e.g., selecting maximum quality/chunk size, when the buffer is full or nearly so, i.e., filling the buffer more slowly using a segment of a higher variant.

In ABR encoding schemes for ABR streaming, for each time block of a video, the encoding bitrates for video chunks (or segments), and hence picture quality, generally increase from lower bitrate to higher bitrate tracks. During playback, the client/video player downloads a manifest file containing meta-data about the different tracks (and the video segments and/or chunks of each track) and resource requirements (e.g., peak rate). The ABR logic at the video player dynamically determines which segment (i.e., from which track) to fetch for each position/time block in the video, which may be based on available network bandwidth and other factors.

Examples of the present disclosure dynamically generate an “ABR ladder,” e.g., a set of bandwidth and resolution encoding pairs, as a function of the source content for encoding a video (or “video program”) for streaming over a network. Specifically, the present disclosure may extract features of the source content, including spatial information (SI), temporal information (TI), and/or an complexity factor, e.g., bits per pixel (BPP) (or bits per other spatial unit, such as bits per macroblock, bits per coding tree unit (CTU), etc.). Next, the present disclosure may train and apply a prediction model (e.g., a machine learning model or other prediction models) that outputs a per-chunk video quality prediction as a function of resolution and bitrate (e.g., of a transcoded version of each chunk), and based upon the features of the source content of the chunk (e.g., a complexity factor, and in one example, further including SI and/or TI). Empirically, the complexity factor appears to be the feature most useful in prediction of video quality of transcoded chunks. Notably, a machine learning workflow (or other predictive model training workflows) may use source features generated from the original full resolution source, while still being able to generate video quality predictions at multiple output video resolutions. In other words, pre-processing the source into multiple resolutions and then calculating a video quality (such as Video Multi-method Assessment Fusion (VMAF), or the like) is not required.

The present disclosure may then build a visual quality ladder, e.g., an ABR ladder, for the video program based on per-chunk video quality predictions from the inference workflow. In one example, the ladder may be generated while taking into account constraints such as the maximum resolution/framerates supported by customer devices, bandwidth constraints imposed by cellular networks, etc. In one example, per-chunk data is aggregated over the entire title to generate the ladder, and then, per-chunk encoding configurations may be selected based on the ladder. Thus, examples of the present disclosure generate a per-title quality ladder that is optimized for video quality and bandwidth efficiency at an order of magnitude lower in computational complexity than existing methods. In addition, the present process is significantly faster because it does not pre-process the source video program into multiple output resolutions.

It should be noted that examples of the present disclosure may implement an adaptive video streaming system in which a video server may provide a manifest file for a video to a client/video player in which the manifest file indicates a plurality of video segments associated with each time block of the video. In one example, the plurality of video segments for each time block of the video may be of different tracks. In other words, the adaptive video streaming may be adaptive bitrate (ABR) streaming, where each video is comprised of different tracks, each track encoded in accordance with a target or nominal visual quality (VQ). In this case, the manifest file may indicate the track to which each of the plurality of video segments of each time block belongs. In addition, the manifest file may indicate for each video segment: a URL or other indicators of where and/or how the client/video player may obtain the segment, the data size/volume of the segment, the playback duration of the segment, and so forth. However, examples of the present disclosure are not limited to track-based ABR streaming. For instance, each time block of a video program may be associated with one or multiple video segments (or chunks comprising one or more segments), each with a different perceptual visual quality, while the segments (or chunks) of the same or similar encoding bitrates for successive time blocks of the video may not be organized into “tracks” per se.

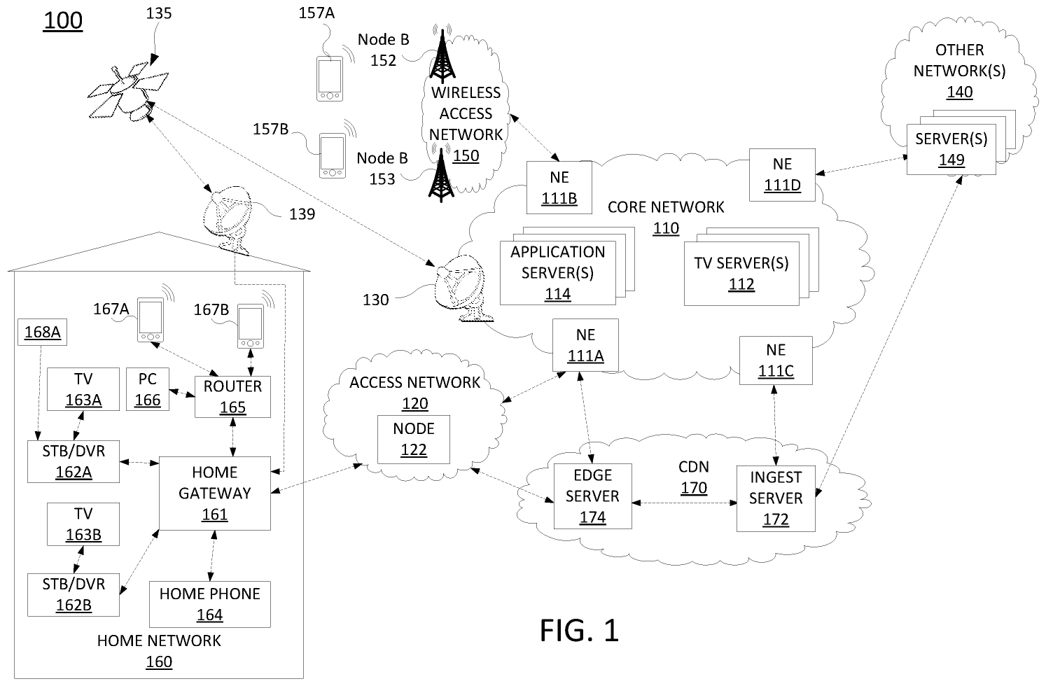

It should also be noted that aspects of the present disclosure are equally applicable to live video streaming and on-demand streaming of recorded video programs. Similarly, although aspects of the present disclosure may be focused upon streaming via cellular networks, the present disclosure is also applicable to other types of networks and network infrastructure, including wired (e.g., home broadband) or wireless networks, satellite, and so forth. These and other aspects of the present disclosure are described in greater detail below in connection with the examples of FIGS. 1-5.

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A and 162B, television (TV) 163A and TV 163B, home phone 164, router 165, personal computer (PC) 166, and so forth, with one another and with various other devices via a core network 110, a wireless access network 150 (e.g., a cellular network), an access network 120, other networks 140, content distribution network (CDN) 170, and/or the Internet in general. For instance, connections between core network 110, access network 120, home network 160, CDN 170, wireless access network 150 and other networks 140 may comprise the Internet in general, internal links under the control of single telecommunication service provider network, links between peer networks, and so forth.

In one example, wireless access network 150 may comprise a radio access network implementing such technologies as: Global System for Mobile Communication (GSM), e.g., a Base Station Subsystem (BSS), or IS-95, a Universal Mobile Telecommunications System (UMTS) network employing Wideband Code Division Multiple Access (WCDMA), or a CDMA3000 network, among others. In other words, wireless access network 150 may comprise an access network in accordance with any “second generation” (2G), “third generation” (3G), “fourth generation” (4G), Long Term Evolution (LTE), “fifth generation” (5G) or any other yet to be developed future wireless/cellular network technology. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB). In one example, wireless access network 150 may be controlled and/or operated by the same entity as core network 110.

In one example, each of the mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one example, any one or more of the mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, wireless access network 150, access network 120, and so forth. As shown in FIG. 1, core network 110 may also include a plurality of television (TV) servers 112, and a plurality of application servers 114. For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may include content server(s) to store scheduled television broadcast content for a number of television channels, video-on-demand (VoD) programming, local programming content, and so forth. Alternatively, or in addition, content providers may stream various contents to the core network 110 for distribution to various subscribers, e.g., for live content, such as news programming, sporting events, and the like. Television servers 112 may also include advertising server(s) to store a number of advertisements that can be selected for presentation to viewers, e.g., in the home network 160 and at other downstream viewing locations. For example, advertisers may upload various advertising content to the core network 110 to be distributed to various viewers. Television servers 112 may also include interactive TV/video-on-demand (VoD) server(s) and/or network-based digital video recorder (DVR) servers, as described in greater detail below.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other types of television service to subscribers via access network 120. In this regard, access network 120 may include a node 122, e.g., a mini-fiber node (MFN), a video-ready access device (VRAD) or the like. However, in another example, node 122 may be omitted, e.g., for fiber-to-the-premises (FTTP) installations. Access network 120 may also transmit and receive communications between home network 160 and core network 110 relating to voice telephone calls, communications with web servers via other networks 140, content distribution network (CDN) 170 and/or the Internet in general, and so forth. In another example, access network 120 may be operated by a different entity from core network 110, e.g., an Internet service provider (ISP) network.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

As illustrated in FIG. 1, core network 110 may include various application servers 114. For instance, application servers 114 may be implemented to provide certain functions or features, e.g., a Serving-Call Session Control Function (S-CSCF), a Proxy-Call Session Control Function (P-CSCF), or an Interrogating-Call Session Control Function (I-CSCF), one or more billing servers for billing one or more services, including cellular data and telephony services, wire-line phone services, Internet access services, and television services. Application servers 114 may also include a Home Subscriber Server/Home Location Register (HSS/HLR) for tracking cellular subscriber device location and other functions. An HSS refers to a network element residing in the control plane of an IMS network that acts as a central repository of all customer specific authorizations, service profiles, preferences, etc. Application servers 114 may also include an IMS media server (MS) for handling and terminating media streams to provide services such as announcements, bridges, and Interactive Voice Response (IVR) messages for VoIP and cellular service applications. The MS may also interact with customers for media session management. In addition, application servers 114 may also include a presence server, e.g., for detecting a presence of a user. For example, the presence server may determine the physical location of a user or whether the user is “present” for the purpose of a subscribed service, e.g., online for a chatting service and the like.

In one example, application servers 114 may include data storage servers to receive and store manifest files regarding chunk-based multi-encoded videos (e.g., track-based or non-track-based multi-bitrate encoded videos for adaptive video streaming, adaptive bitrate video streaming, etc. and/or videos that are represented, e.g., for a given video, as multiple video chunks encoded at multiple perceptual visual quality levels for each time block of the video), maintained within TV servers 112 and/or available to subscribers of core network 110 and stored in server(s) 149 in the other networks 140. It should be noted that the foregoing are only several examples of the types of relevant application servers 114 that may be included in core network 110 for storing information relevant to providing various services to subscribers.

In accordance with the present disclosure, other networks 140 and servers 149 may comprise networks and devices of various content providers of videos (or “video programs”). In one example, each of the servers 149 may also make available manifest files which describe the variants of a video and the segments/video chunks thereof which are stored on the respective one of the servers 149. For instance, there may be several video segments containing video and audio for the same time block (e.g., a portion of 2-10 seconds) of the video, but which are encoded at different bitrates in accordance with an adaptive bitrate streaming protocol and/or which have different perceptual visual qualities. Thus, streaming video player (e.g., an ABR streaming video player) may request and obtain any one of the different video segments for the time block, e.g., in accordance with ABR streaming logic, depending upon a state of a video buffer, depending upon network bandwidth or other network conditions, depending upon the access rights of the streaming video player to different variants (e.g., to different encoding levels/bitrates) according to a subscription plan and/or for the particular video, and so forth.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

Among other functions, STB/DVR 162A and STB/DVR 162B may comprise streaming video players (e.g., adaptive streaming video players) capable of streaming and playing multi-encoded videos in formats such as H.264 (Advanced Video Coding (AVC)), H.265 (High Efficiency Video Coding (HEVC)), Moving Picture Expert Group (MPEG) .mpeg files, .mov files, .mp4 files, .3gp files, .f4f files, .m3u8 files, or the like. Although STB/DVR 162A and STB/DVR 162B are illustrated and described as integrated devices with both STB and DVR functions, in other, further, and different examples, STB/DVR 162A and/or STB/DVR 162B may comprise separate STB and DVR devices. It should be noted that in one example, one or more of mobile devices 157A, 157B, 167A and 167B, and/or PC 166 may also comprise adaptive streaming video players.

Network 100 may also include a content distribution network (CDN) 170. In one example, CDN 170 may be operated by a different entity from the core network 110. In another example, CDN 170 may be operated by the same entity as the core network 110, e.g., a telecommunication service provider. In one example, the CDN 170 may comprise a collection of cache servers distributed across a large geographical area and organized in a tier structure. The first tier may comprise a group of servers that accesses content web servers (e.g., origin servers) to pull content into the CDN 170, referred to as an ingestion servers, e.g., ingest server 172. The content may include videos, content of various webpages, electronic documents, video games, etc. A last tier may comprise cache servers which deliver content to end user, referred to as edge caches, or edge servers, e.g., edge server 174. For ease of illustration, a single ingest server 172 and a single edge server 174 are shown in FIG. 1. In between the ingest server 172 and edge server 174, there may be several layers of servers (omitted from the illustrations), referred to as the middle tier. In one example, the edge server 174 may be multi-tenant, serving multiple content providers, such as core network 110, content providers associated with server(s) 149 in other network(s) 140, and so forth.

As mentioned above, TV servers 112 in core network 110 may also include one or more interactive TV/video-on-demand (VoD) servers and/or network-based DVR servers. In one example, an interactive TV/VoD server and/or DVR server may comprise streaming video servers (e.g., adaptive video streaming servers). Among other things, an interactive TV/VoD server and/or network-based DVR server may function as a server for STB/DVR 162A and/or STB/DVR 162B, one or more of mobile devices 157A, 157B, 167A and 167B, and/or PC 166 operating as a client/adaptive streaming-configured video player for requesting and receiving a manifest file for a multi-encoded video, as described herein. For example, STB/DVR 162A may present a user interface and receive one or more inputs (e.g., via remote control 168A) for a selection of a video. STB/DVR 162A may request the video from an interactive TV/VoD server and/or network-based DVR server, which may retrieve the manifest file for the video from one or more of application servers 114 and provide the manifest file to STB/DVR 162A. STB/DVR 162A may then obtain video segments of the video as identified in the manifest file and in accordance with adaptive streaming logic.

In one example, the manifest file may direct the STB/DVR 162A to obtain the video segments (and/or chunks comprising one or more segments) from edge server 174 in CDN 170. The edge server 174 may have already stored the video segments and/or chunks of the video and may then deliver the video segments and/or chunks upon a request from the STB/DVR 162A. However, if the edge server 174 does not already possess the video chunks, upon request from the STB/DVR 162A, the edge server 174 may in turn request the video chunks from an origin server. The origin server which stores segments and/or chunks of the video may comprise, for example, one of the servers 149 or one of the TV servers 112. The segments and/or chunks of the video may be obtained from the origin server via ingest server 172 before passing to edge server 174. In one example, the ingest server 172 may also pass the video segments and/or chunks to other middle tier servers and/or other edge servers (not shown) of CDN 170. The edge server 174 may then deliver the video segments and/or chunks to the STB/DVR 162A and may store the video segments and/or chunks locally until the video chunks are removed or overwritten from the edge server 174 according to any number of criteria, such as a least recently used (LRU) algorithm for determining which content to keep in the edge server 174 and which content to delete and/or overwrite.

It should be noted that a similar process may involve other devices, such as TV 163A or TV 163B (e.g., “smart” TVs), mobile devices 167A, 167B, 157A or 157B obtaining a manifest file for a video from one of the TV servers 112, from one of the servers 149, etc., and requesting and obtaining video segments and/or chunks of the video from edge server 174 of CDN 170. In this regard, it should be noted that the edge server 174 may comprise a server that is closest to the requesting device geographically or in terms of network latency, throughput, etc., or which may have more spare capacity to serve the requesting device as compared to other edge servers, which may otherwise best serve the video to the requesting device, etc. However, depending upon the location of the requesting device, the access network utilized by the requesting device, and other factors, the segments and/or chunks of the video may be delivered via various networks, various links, and/or various intermediate devices. For instance, in one example, edge server 174 may deliver video segments and/or chunks to a requesting device in home network 160 via access network 120, e.g., an ISP network. In another example, edge server 174 may deliver video segments and/or chunks to a requesting device in home network 160 via core network 110 and access network 120. In still another example, edge server 174 may deliver video segments and/or chunks to a requesting device such as mobile device 157A or 157B via core network 110 and wireless access network 150.

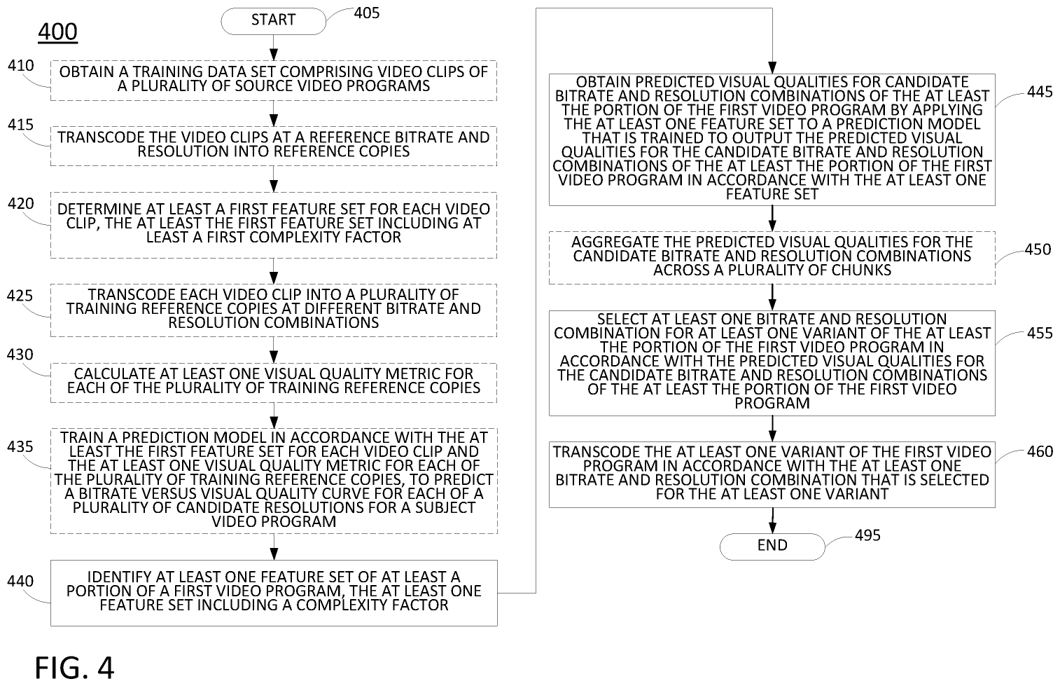

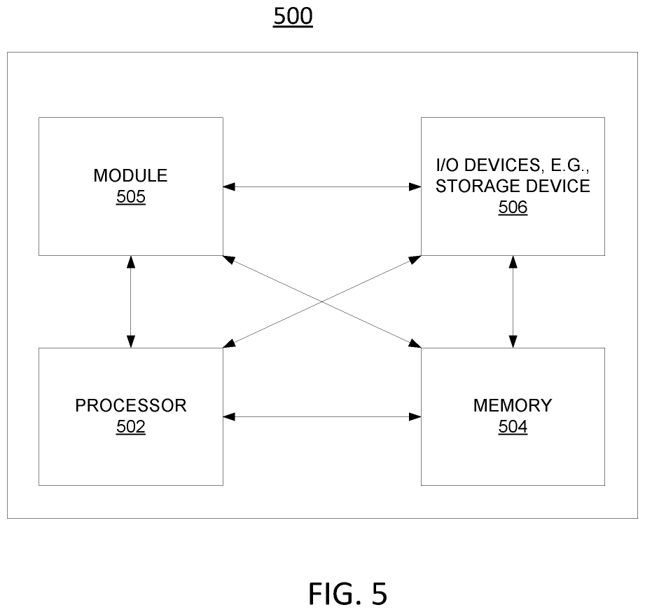

It should also be noted that in accordance with the present disclosure, any one or more devices of system 100 may perform operations for generating different video chunks/bitrate variants for time blocks of a video and/or for generating different tracks of a video (e.g., ABR encoders or the like), for generating a manifest file for the video, and so on, such as one or more of application servers 114, TV servers 112, ingest server 172, edge server 174, one or more of servers 149, and so forth. For instance, any one or more of such devices may comprise a processing system to create, store, and/or stream video chunks for variants of ABR videos (or “multi-encoded videos”), as well as to perform other functions. For example, any one or more of application servers 114, TV servers 112, ingest server 172, edge server 174, servers 149, and so forth may comprise all or a portion of a computing device or system, such as computing system 500, and/or processing system 502 as described in connection with FIG. 5 below, specifically configured to perform various steps, functions, and/or operations for transcoding variants of a video program in accordance with bitrate and resolution combinations selected for the variants based on predicted visual qualities for candidate bitrate and resolution combinations of at least a portion of the video program (e.g., in accordance with the example method 400 illustrated in FIG. 4 and described in greater detail below).

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 5 and discussed below) or multiple computing devices collectively configured to perform various steps, functions, and/or operations in accordance with the present disclosure.

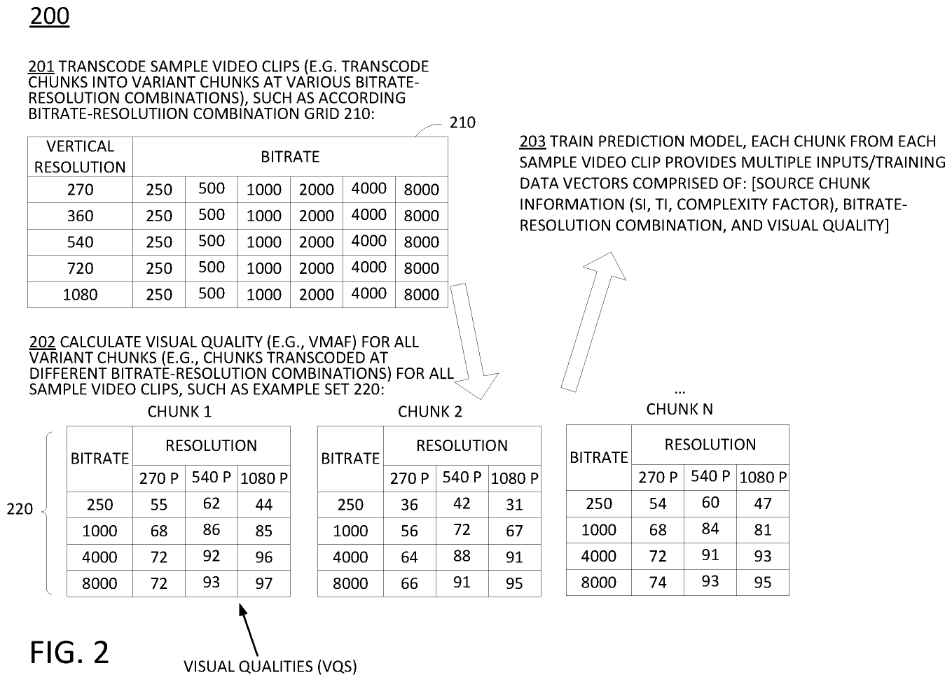

Further details regarding the functions that may be implemented by application servers 114, TV servers 112, ingest server 172, servers 149, STBs/DVRs 162A and 162B, TV 163A, TV 163B, mobile devices 157A, 157B, 167A and 167B, and/or PC 166 are discussed in greater detail below in connection with the example of FIG. 2. In addition, it should be noted that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

To further aid in understanding the present disclosure FIG. 2 illustrates an example process 200 for generating training data for training a prediction model in accordance with the present disclosure. For instance, as shown in FIG. 2, the process 200 may begin at stage 201 where a processing system may transcode sample video clips at various bitrate-resolution combinations. In one example, stage 201 may include or may be preceded by obtaining various video clips, each comprising one or more chunks, e.g., each comprising one or more segments corresponding to respective time blocks within respective videos/video programs. In one example, the sample video clips may be selected from approximately 100 or more randomly selected movies or other types of video content with different subjects including action, sports, cartoons, etc. In one example, the video clips may comprise shots or scenes of the respective videos/video programs. In one example, stage 201 may also include or be preceded by sampling of chunks or similar sub-units from the respective sampled video clips (e.g., four chunks from each video clip and/or video program, 10 chunks, etc.). In one example, sample video clips and/or sampled chunks from within the sampled video clips may be selected for use in a prediction model training phase so as to ensure that samples comprising high, medium, and low complexity factors are represented (e.g., relatively equally represented).

Thus, stage 201 may include transcoding the sample video clips (e.g., representative chunks thereof) at various bitrate-resolution combinations. In one example, the various bitrate-resolution combinations may be according to a bitrate-resolution combination grid 210. It should be noted that this is just one example, and that in other, further, and different examples, different resolutions and/or different bitrates may be used, more or less resolutions and/or bitrates may be used, and so forth. In any case, for each chunk of each sample video clip, the transcoding may result in a plurality of variant chunks (e.g., containing the same content for the same time block of the video program, but at lesser bitrate and/or resolution as compared to the original chunk from the sample video clip).

At stage 202, the processing system may calculate visual qualities for all variant chunks generated at stage 201. For instance, the example set 220 may include results for all of these various chunks, represented by chunk 1, chunk 2, and chunk N. It should be noted that the grid 210 includes a larger number of resolution-bitrate combinations. However, for illustrative purposes, the example set 220 includes a lesser number (e.g., four bitrates and three resolutions, for a total of 12 bitrate-resolution combinations). It is again noted that in other, further, and different examples, different resolutions and/or different bitrates may be used, more or less resolutions and/or bitrates may be used, and so forth. In one example, each measured/computed visual quality (VQ) may comprise a Video Multi-method Assessment Fusion (VMAF) metric. For instance, a VMAF score may be determined via a comparison of an encoded video portion to a corresponding source video portion and may range from 0 to 100, where a difference of 6 is considered a just-noticeable difference (JND). In other examples, the VQ may comprise a structural similarity index measure (SSIM), visual information fidelity (VIF) metric, video quality metric (VQM), detail loss metric (DLM), mean co-located pixel difference (MCPD), peak signal-to-noise ratio (PSNR), Picture Quality Rating (PQR), Attention-weighted Difference Mean Opinion Score (ADMOS), etc. In one example, the transcoding may comprise transcoding with the bitrates illustrated in FIG. 2 representing target average bitrates, where variable bitrate encoding is applied. In addition, a peak bitrate threshold may be applied, such as no more than 30 percent in excess of a given target average bitrate, no more than double the target average bitrate, etc.

At stage 203, the processing system may train a prediction model (e.g., a machine learning model (MLM) or other prediction models) to infer/predict visual quality for each possible bitrate and resolution combination for a given chunk of a video/video program. In one example, the prediction model may be trained and/or learned based upon input vectors comprising source information (e.g., a complexity factor (e.g., bits-per-pixel (BPP) or the like), and in one example, further including spatial information (SI), temporal information (TI), and/or other factors), a resolution, a bitrate (e.g., the resolution and bitrate together comprising a “resolution and bitrate combination”), and a visual quality calculated for the resolution and bitrate combination at stage 202. In one example, the prediction model may comprise an extreme gradient boosting (XGBoost) model (or “XGBRegressor” (XGBR) model). However, a different MLM or other non-MLM prediction models may be used in various other examples.

For instance, in accordance with the present disclosure, a machine learning algorithm (MLA), or machine learning model (MLM) trained via a MLA for predicting visual quality as a function of source information, resolution, and bitrate (e.g., a machine learning prediction model) may comprise a deep learning neural network, or deep neural network (DNN), a convolutional neural network (CNN), a generative adversarial network (GAN), a decision tree algorithm/model, such as gradient boosted decision tree (GBDT) (e.g., XGBoost, XGBR, or the like), a support vector machine (SVM), e.g., a non-binary, or multi-class classifier, a linear or non-linear classifier, k-means clustering and/or k-nearest neighbor (KNN) predictive models, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. Similarly, a regression-based prediction model may be trained and used for prediction, such as linear regression, polynomial regression, ridge regression, lasso regression, etc., where the regression-based prediction model is learned/regressed using the source information, resolution, and bitrate as predictors, and the visual quality as the dependent variable/output. In one example, the sample video clips may be segregated into training and testing data, and the prediction model may be trained until a desired accuracy is reached, e.g., 90 percent accuracy, 95 percent accuracy, etc.

In one example, each sample video clip may have a same relatively high resolution, e.g., 1080 pixels vertical resolution, or the like. In one example, the SI and TI may be obtained for each sample video clip and may be as defined by International Telecommunication Union Telecommunication Standardization Sector (ITU-T) Recommendation P.910, or similar. In one example, the complexity factor, e.g., bits per pixel (BPP), quantifies video complexity as a ratio between how many bits are used to store information on each pixel. In one example, the BPP of a sample video clip may be calculated as the bitrate divided by the pixels per second of the sample video clip (or similarly for the BPP of a chunk or other sub-units of the sample video clip). For purposes of this calculation, the bitrate may be the average bitrate of an encoding performed to a mid-range bitrate. In one example, the encoding is performed via an H.264/Advanced Video Coding (AVC) encoder, such as x264. In one example, a “veryfast” preset and fixed constant rate factor (CRF) parameters may be used. In addition, the pixels per second may be calculated as the video height times the video width times frames per second (FPS) of the video clip (or chunk or other sub-units thereof). In one example, the CRF may be selected to provide a reference copy of the video clip (or chunk or other sub-units thereof) encoded to roughly correspond to a mid-range visual quality of ABR videos to be offered by a video delivery platform. It should be noted that this is just one example of calculating a complexity factor and that other, further, and different examples may calculate the complexity factor, SI, and/or TI in a different way. For example, the encoding may be in accordance with H.265/High Efficiency Video Coding (HEVC), VP9, AV1 (AOMedia Video 1), etc. In another example, the complexity factor may comprise a bits per coding tree unit (CTU), bits per block, bits per macroblock, or the like, and so forth. Thus, these and other modifications are all contemplated within the scope of the present disclosure.

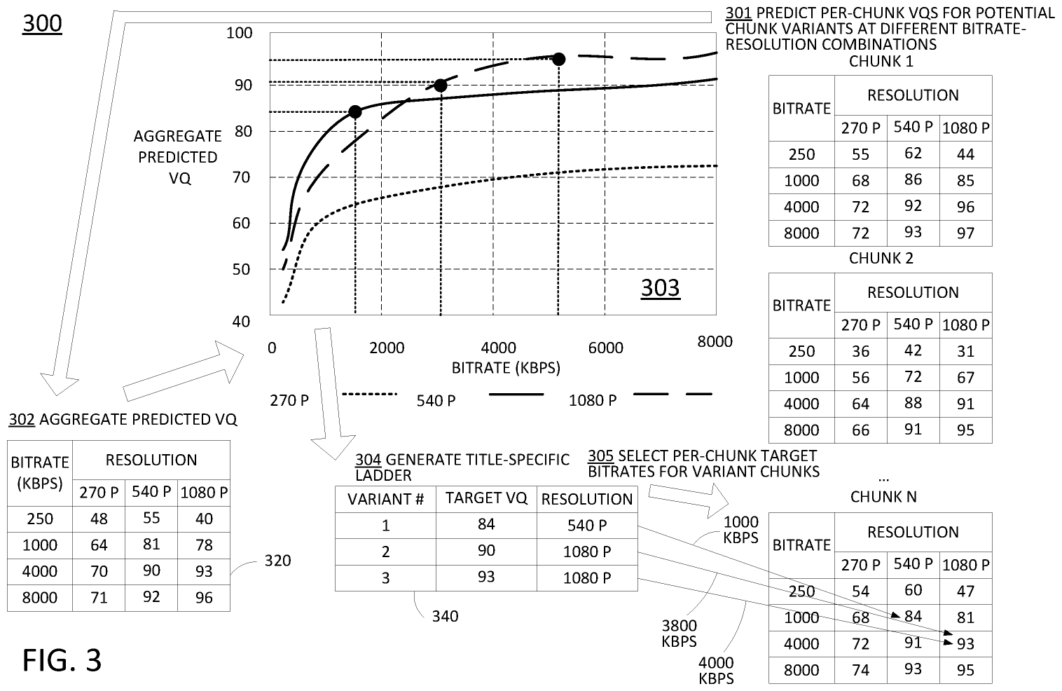

FIG. 3 illustrates an example process 300 in which a trained prediction model is used to predict visual qualities of tracks/variants of a source video program from which a per-title, video-specific quality ladder and per-chunk target bitrates for variant chunks may be selected. In one example, the prediction model may be trained via the example process 200 of FIG. 2. To illustrate, in a first stage 301, a processing system may predict per-chunk visual qualities (VQs) for potential chunk variants at different bitrate and resolution (bitrate-resolution) combinations. For instance, this is illustrated in FIG. 3 for chunk 1, chunk 2, and chunk N of the video program. In one example, VQs may be predicted for the entirety of the video program (e.g., all chunks or other sub-units thereof). In another example, VQs may be predicted for chunk variants for less than all chunks (or other sub-units) of the video program (e.g., every other chunk, every 5^{th} chunk, randomly sampled chunks, etc.).

At a second stage 302, the processing system may aggregate predicted VQs among all chunks of the video program (and/or from sampled chunks of the video program, e.g., every other chunk, every fifth chunk, randomly sampled chunks, etc.). For instance, this may comprise an averaging of the predicted VQs for the same bitrate-resolution combinations across the various chunks. In one example, the averaging may not be a linear averaging, but may be weighted with greater weighting on mid-range values and lesser weighting on outlier values (e.g., predicted VQs that fall toward the upper and lower ends of a range of VQs for a same bitrate-resolution combination), may include discarding outliers and/or a top N percent of VQ values toward the upper and lower ends of a range of VQs for a same bitrate-resolution combination (such as discarding the top 5% of VQ values and bottom 5% of VQ values), and so forth.

An example result of the aggregating is illustrated in table 320. In addition, an example graph 303 visualizes the results by plotting bitrate versus aggregate predicted VQ for three different resolutions (e.g., 270p, 540p, and 1080p). The respective curves are interpolated/fitted based upon the sample points provided from table 320. In one example, target visual qualities for different tracks/variants to be generated from the source video program may be established or selected (e.g., by a video creator, by a network operator and/or television service provider, by a video storage and/or delivery platform, etc.). For illustrative purposes, visual qualities of 84, 90, and 93 may be selected for three tracks/variants (with variant 3 being the highest quality variant/track, and variant 1 being the lowest quality variant/track). From these target visual qualities, at stage 304 the resolutions for the respective variants may then be selected based upon the aggregate predicted VQs for different bitrate-resolution combinations. For instance, a resolution may be selected for the variant/track that can provide the target visual quality assigned to the variant/track with a lowest bitrate as compared to other resolutions.

To illustrate, graph 303 includes reference lines which show how these VQs may be mapped to respective resolutions. For example, for the target VQ of 84 for variant 1, the resolution of 540p can provide the target VQ at the lowest average bitrate (e.g., approximately 1700 Kbps). Similarly, for the target VQ of 90 for variant 2, the resolution of 1080p can provide the target VQ at the lowest average bitrate (e.g., approximately 3000 Kbps). Lastly, for the target VQ of 93 for variant 3, the resolution of 1080p can provide the target VQ at the lowest average bitrate (e.g., approximately 5200 Kbps). Table 340 illustrates the resulting selections of resolutions matched to the target VQs for the respective variants. In one example, the selection may be constrained or modified based upon stream saver thresholds, max codec profile/level, a maximum average bitrate for a highest quality variant, and so forth.

In one example, the present disclosure may additionally determine and apply per-chunk target bitrates for variant chunks at stage 305. For example, instead of encoding an entire track/variant at the average bitrate indicated per graph 303 to provide the aggregate predicted visual quality over the entire track/variant, the present disclosure may apply per-chunk target bitrates that are expected to provide the target VQ assigned to the track/variant. Notably, this may provide even further storage and/or streaming bandwidth savings, while maintaining the same visual quality. For instance, a lesser average bitrate may be used while maintaining the same visual quality. To illustrate, for variant 1 the target VQ is 84 and the resolution is selected to be 540p (e.g., as shown in table 340). Using the resolution and target VQ, the present disclosure may then find the bitrate that, in combination with the selected resolution, will provide the target VQ for a given variant chunk. It is again noted that a variant chunk is a transcoded version of a chunk of the original video program, and thus corresponds to the same time block of the video program and represents the same content. In this case, for a resolution of 540p and target VQ of 84 for variant 1, the average bitrate that is expected to provide the VQ of 84 for a track variant of chunk N belonging to variant 1 is 1000 Kbps. Similarly, for a resolution of 1080p and target VQ of 93 for variant 3, the average bitrate that is expected to provide the VQ of 93 for a track variant of chunk N belonging to variant 3 is 4000 Kbps. Notably, for a resolution of 1080p and target VQ of 90 for variant 2, the average bitrate that is expected to provide the VQ of 90 for a track variant of chunk N belonging to variant 2 is approximately 3800 Kbps. In particular, it should be noted that the VQ of 90 falls between the VQs predicted for specific bitrate-resolution combinations for chunk N shown in FIG. 3. In one example, the present disclosure may interpolate between these VQ values to determine a bitrate corresponding to an intermediate VQ. In one example, the prediction model may generate outputs on a continuous scale. Thus, in one example, the present disclosure may iteratively apply input vectors to the prediction model (e.g., source information (e.g., comprising at least a complexity factor, and in some examples further including SI and/or TI), resolution, and bitrate) where the bitrate is changed for each input vector until the target VQ is obtained as an output. In addition, a processing system may apply the same procedure to chunk 1, chunk 2, and so forth for all three variants/tracks and for the entire video program.

FIG. 4 illustrates a flowchart of an example method 400 for transcoding variants of a video program in accordance with bitrate and resolution combinations selected for the variants based on predicted visual qualities for candidate bitrate and resolution combinations of at least a portion of the video program, in accordance with the present disclosure. In one example, the method 400 is performed by a component of the system 100 of FIG. 1, such as by application server(s) 114, TV server(s) 112, server(s) 149, ingest server 172, edge server 174, etc., and/or any one or more components thereof (e.g., a processor, or processors, performing operations stored in and loaded from a memory), by application server(s) 114, TV server(s) 112, server(s) 149, ingest server 172, and/or edge server 174, in conjunction with one or more other devices or computing/processing systems, e.g., STB/DVR 162A, STB/DBR 162B, TV 163A, TV 163B, mobile devices 157A, 157B, 167A, and/or 167B, PC 166, and so forth. In one example, the steps, functions, or operations of method 400 may be performed by a computing device or system 500, and/or processor 502 as described in connection with FIG. 5 below. For instance, the computing device or system 500 may represent any one or more components of a device, server, and/or application server in FIG. 1 that is/are configured to perform the steps, functions and/or operations of the method 400. Similarly, in one example, the steps, functions, or operations of method 400 may be performed by a processing system comprising one or more computing devices collectively configured to perform various steps, functions, and/or operations of the method 400. For instance, multiple instances of the computing device or processing system 500 may collectively function as a processing system. For illustrative purposes, the method 400 is described in greater detail below in connection with an example performed by a processing system. The method 400 begins in step 405 and may proceed to optional step 410 or to step 440.

At optional step 410, the processing system may obtain a training data set comprising video clips of a plurality of source video programs. For instance, the video clips may be from randomly selected videos, randomly selected videos from among various categories, etc. In one example, a video clip may comprise less than all of a video program (e.g., a selected portion, or selected portions of the video program). However, in another example, a video clip may comprise an entire program.

At optional step 415, the processing system may transcode the video clips at a reference bitrate and resolution into reference copies. For instance, optional step 415 may be performed via an H.264/AVC encoder, such as an x264 encoder, an H.265/HEVC encoder, a VP9 encoder, an AV1 encoder, or the like (e.g., depending upon the video format in which ABR tracks/variants of a video program are to be offered). In one example, the reference copies may be encoded with a CRF selected to provide a mid-range visual quality from among visual qualities of ABR videos to be offered by a video delivery platform. In one example, the transcoding of optional step 415 may be with respect to all or a selected portion of a video clip (e.g., a chunk or selected chunks thereof). It should be noted that as referred to herein, a chunk may broadly comprise a temporal block of a video program, e.g., a group of sequential frames, a group of pictures (GOP) or several sequential GOPs, one or more “segments.” etc. In one example, a chunk may comprise a shot or a scene of a video/video program.

At optional step 420, the processing system may determine at least a first feature set for each video clip, the at least the first feature set including at least a first complexity factor. In one example, the complexity factor may comprise a bits-per-pixel measure of a video clip. In another example, the complexity factor may comprise a measure of bits per other spatial unit associated with a video clip, where the other spatial unit may comprise a coding tree unit (CTU), a macroblock, a frame, etc. In one example, the at least the first feature set may further include at least first spatial information (SI) and/or at least first temporal information (TI), as discussed above. In one example, the at least the first feature set may be determined with respect to at least one chunk of a video clip. In an example in which multiple chunks are used from a video clip, there may be multiple feature sets determined at optional step 420, e.g., one per chunk. In one example, the at least the first feature set for each video clip may be determined with respect to one of the reference copies transcoded at optional step 215.

At optional step 425, the processing system may transcode each video clip into a plurality of training reference copies at different bitrate and resolution combinations. For instance, optional step 425 may be performed via an H.264/AVC encoder, such as an x264 encoder, an H.265/HEVC encoder, a VP9 encoder, an AV1 encoder, or the like (e.g., depending upon the video format in which ABR tracks/variants of a video program are to be offered). In one example, optional step 425 may comprise transcoding selected chunks of each video clip into respective chunk variants, such as described above (e.g., less than the entirety of the video clip).

At optional step 430, the processing system may calculate at least one visual quality metric for each of the plurality of training reference copies. In one example, the at least one visual quality metric may comprise a VMAF metric. In other examples, the at least one visual quality metric may comprise a structural similarity index measure (SSIM), visual information fidelity (VIF) metric, detail loss metric (DLM), mean co-located pixel difference (MCPD), peak signal-to-noise ratio (PSNR), Picture Quality Rating (PQR), Attention-weighted Difference Mean Opinion Score (ADMOS), etc. In one example, the at least one visual quality metric may comprise a plurality of visual quality metrics per training reference copy (e.g., one visual quality metric per variant chunk of the training reference copy).

At optional step 435, the processing system may train a prediction model in accordance with the at least the first feature set for each video clip and the at least one visual quality metric for each of the plurality of training reference copies, to predict a bitrate versus visual quality curve for each of a plurality of candidate resolutions for a subject video program. In one example, the prediction model may comprise an XGBR model. In other examples, the prediction model may comprise an XGBoost model, an adaptive boosting (AdaBoost) model, or a different type of gradient boosted machine (GBM), a deep neural network (DNN), a convolutional neural network (CNN), a regression model (e.g., a regression-based prediction model) such as linear regression, polynomial regression, ridge regression, lasso regression, etc.

At step 440, the processing system identifies at least one feature set of at least a portion of a first video program, the at least one feature set including a complexity factor (and in some examples, further including SI and/or TI). For instance, the identification of the at least one feature set may be the same or similar as described above in connection with optional step 420. In one example, the at least one feature set may comprise multiple feature sets, e.g., one per chunk or other portion of the first video program. In one example, the at least the portion may comprise a plurality of chunks, e.g., all chunks of the video program or a sampling of chunks.

At step 445, the processing system obtains predicted visual qualities for candidate bitrate and resolution combinations of the at least the portion of the first video program. For instance, step 445 may comprise applying the at least one feature set to a prediction model that is trained to output the predicted visual qualities for the candidate bitrate and resolution combinations of the at least the portion of the first video program in accordance with the at least one feature set. For instance, in one example, the prediction model may be trained via optional steps 410-435 as described above. In one example, the predicted visual qualities may comprise predicted visual qualities for the different candidate bitrate and resolution combinations for the plurality of chunks (e.g., for potential transcoded variant chunks of a plurality of chunks of the original first video program).

At optional step 450, the processing system may aggregate the predicted visual qualities for the different candidate bitrate and resolution combinations across a plurality of chunks of the at least the portion of the first video program. For instance, optional step 450 may comprise operations such as described above in connection with stage 302 of FIG. 3.

At step 455, the processing system selects at least one bitrate and resolution combination for at least one variant of the at least the portion of the first video program in accordance with the predicted visual qualities for the candidate bitrate and resolution combinations of the at least the portion of the first video program. In one example, the at least one variant may comprise a plurality of variants. In addition, in such an example, the at least one bitrate and resolution combination may comprise bitrate and resolution combinations for the plurality of variants. In one example, each variant of the plurality of variants is assigned a target visual quality. Accordingly, in one example, step 455 may comprise, for each variant, selecting a resolution that can provide the target visual quality assigned to the variant with a lowest bitrate as compared to other resolutions. In one example, the resolution may be determined to provide the target visual quality assigned to the variant with a lowest bitrate as compared to other resolutions in accordance with the predicted visual qualities that may be aggregated at optional step 450. In one example, the selecting of the bitrate and resolution combinations for the plurality of variants of the at least the portion of the first video program may be in accordance with a bitrate versus visual quality curve for each of a plurality of resolutions. In one example, combinations of target visual quality and selected resolutions comprise a quality ladder, e.g., an ABR ladder, for the plurality of variants. In one example, the curves may be obtained from the aggregated predicted visual qualities for the different candidate bitrate and resolution combinations for the plurality of chunks.

In one example, each variant of the plurality of variants comprises a plurality of variant chunks. Accordingly, in one example, step 450 may further comprise, for each variant chunk of each variant of the plurality of variants, selecting a bitrate for the variant chunk as a lowest bitrate that is predicted to achieve the target visual quality assigned to the variant of the variant chunk at the resolution that is selected for the variant of the variant chunk. In one example, the lowest bitrate for each variant chunk may be identified in accordance with a bitrate versus visual quality curve for the resolution that is selected for the variant of the variant chunk, e.g., where the bitrate versus visual quality curve is specific to a chunk of the plurality of chunks of the video program associated with the variant chunk. In one example, the processing system may interpolate between predicted VQ values to determine a bitrate corresponding to an intermediate VQ for a given resolution. In one example, the processing system may iteratively apply input vectors to the prediction model with changing bitrates and the remainder of the parameters fixed until the target VQ is obtained as an output. For instance, in one example, step 455 may comprise operations such as described above in connection with stage 305 of FIG. 3. Accordingly, the bitrate and resolution combinations for the plurality of variants may comprise bitrate and resolution combinations for each of the plurality of variant chunks for each of the plurality of variants, where for each variant chunk, a bitrate and resolution combination includes the bitrate that is selected for the variant chunk and the resolution that is selected for the variant of the variant chunk (where “variant of the variant chunk” is the variant to which the variant chunk belongs).

At step 460, the processing system transcodes the at least one variant of the first video program in accordance with the at least one bitrate and resolution combination that is selected for the at least one variant. As noted above, in one example, the at least one variant may comprise a plurality of variants. Thus, for instance, in one example, step 460 may comprise transcoding each of the plurality of chunks of the first video program in accordance with the bitrate and resolution combinations that are selected into a plurality of variant chunks. In one example, step 460 may comprise the same or similar operations as describe above in connection with optional step 425. In one example, the result of step 460 is a set of tracks/variants of the first video program that can be requested and streamed to a requesting device.

Following optional step 460 the method 400 may proceed to step 495. At step 495 the method 400 ends.

It should be noted that the method 400 may be expanded to include additional steps, or may be modified to replace steps with different steps, to combine steps, to omit steps, to perform steps in a different order, and so forth. For instance, in one example the processing system may repeat one or more steps of the method 400 such as for a different video program, for retraining the prediction model, and so forth. In one example, the method 400 may include generating a manifest file, publishing the manifest file to be used as a resource for obtaining the video program (e.g., the variant chunks of different variants in accordance with an ABR player logic), storing the variants/tracks at one or more servers, delivering the variants/tracks to player devices via one or more networks, etc. In one example, the method 400 may be expanded or modified to include steps, functions, and/or operations, or other features described above in connection with the example(s) of FIGS. 1-3, or as described elsewhere herein. Thus, these and other modifications are all contemplated within the scope of the present disclosure.

In addition, although not expressly specified above, one or more steps of the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 5 depicts a high-level block diagram of a computing device or processing system 500 specifically programmed to perform the functions described herein. For example, any one or more components or devices illustrated in FIG. 1 or described in connection with the examples of FIGS. 2-4 may be implemented as the system 500. As depicted in FIG. 5, the processing system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for transcoding variants of a video program in accordance with bitrate and resolution combinations selected for the variants based on predicted visual qualities for candidate bitrate and resolution combinations of at least a portion of the video program, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 506 may also include antenna elements, transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s), or the entire method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 502 can also be configured or programmed to cause other devices to perform one or more operations as discussed above. In other words, the hardware processor 502 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 505 for transcoding variants of a video program in accordance with bitrate and resolution combinations selected for the variants based on predicted visual qualities for candidate bitrate and resolution combinations of at least a portion of the video program (e.g., a software program comprising computer-executable instructions) can be loaded into memory 504 and executed by hardware processor element 502 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for transcoding variants of a video program in accordance with bitrate and resolution combinations selected for the variants based on predicted visual qualities for candidate bitrate and resolution combinations of at least a portion of the video program (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
identifying, by a processing system including at least one processor, at least one feature set of at least a portion of a first video program, the at least one feature set including a complexity factor;
obtaining, by the processing system, predicted visual qualities for candidate bitrate and resolution combinations of the at least the portion of the first video program by applying the at least one feature set to a prediction model that is trained to output the predicted visual qualities for the candidate bitrate and resolution combinations of the at least the portion of the first video program in accordance with the at least one feature set;
selecting, by the processing system, at least one bitrate and resolution combination for at least one variant of the at least the portion of the first video program in accordance with the predicted visual qualities for the candidate bitrate and resolution combinations of the at least the portion of the first video program; and
transcoding, by the processing system, the at least one variant of the first video program in accordance with the at least one bitrate and resolution combination that is selected for the at least one variant.

2. The method of claim 1, wherein the at least the portion of the first video program comprises a plurality of chunks of the first video program, and wherein the at least one feature set comprises a plurality of feature sets, where each of the plurality of feature sets is associated with a different one of the plurality of chunks of the first video program.

3. The method of claim 2, wherein the predicted visual qualities comprise predicted visual qualities for the candidate bitrate and resolution combinations for the plurality of chunks.

4. The method of claim 3, further comprising:
aggregating the predicted visual qualities for the candidate bitrate and resolution combinations across the plurality of chunks.

5. The method of claim 4, wherein the selecting is based upon the predicted visual qualities that are aggregated.

6. The method of claim 4, wherein the at least one variant comprises a plurality of variants, wherein each variant of the plurality of variants is assigned a target visual quality, wherein the selecting comprises, for each variant:
selecting a resolution that is capable of providing the target visual quality assigned to the variant with a lowest bitrate as compared to other resolutions.

7. The method of claim 6, wherein the resolution is determined to provide the target visual quality assigned to the variant with a lowest bitrate as compared to other resolutions in accordance with the predicted visual qualities that are aggregated.

8. The method of claim 6, wherein the selecting is in accordance with a bitrate versus visual quality curve for each of a plurality of resolutions.

9. The method of claim 6, wherein each variant of the plurality of variants comprises a plurality of variant chunks, wherein the selecting further comprises, for each variant chunk of each variant of the plurality of variants:
selecting a bitrate for the variant chunk as a lowest bitrate that is predicted to achieve the target visual quality assigned to the variant of the variant chunk at the resolution that is selected for the variant of the variant chunk.

10. The method of claim 9, wherein the lowest bitrate for each variant chunk is identified in accordance with a bitrate versus visual quality curve for the resolution that is selected for the variant of the variant chunk, wherein the bitrate versus visual quality curve is specific to a chunk of the plurality of chunks of the first video program associated with the variant chunk.

11. The method of claim 9, wherein the at least one bitrate and resolution combination comprises bitrate and resolution combinations for the plurality of variants, wherein the bitrate and resolution combinations for the plurality of variants comprise bitrate and resolution combinations for each of the plurality of variant chunks for each of the plurality of variants, wherein for each variant chunk, a bitrate and resolution combination includes the bitrate that is selected for the variant chunk and the resolution that is selected for the variant of the variant chunk.

12. The method of claim 3, wherein the transcoding comprises:
transcoding each of the plurality of chunks in accordance with the at least one bitrate and resolution combination that is selected into a plurality of variant chunks.

13. The method of claim 1, wherein the at least one feature set further includes spatial information and temporal information.

14. The method of claim 1, further comprising:
obtaining a training data set comprising video clips of a plurality of source video programs;
determining at least a first feature set for each video clip, the at least the first feature set including at least a first complexity factor;
transcoding each video clip into a plurality of training reference copies at different bitrate and resolution combinations;
calculating at least one visual quality metric for each of the plurality of training reference copies; and
training the prediction model in accordance with the at least the first feature set for each video clip and the at least one visual quality metric for each of the plurality of training reference copies, to predict a bitrate versus visual quality curve for each of a plurality of candidate resolutions for a subject video program.

15. The method of claim 14, wherein the at least the first complexity factor comprises a measure of bits per spatial unit associated with a video clip.

16. The method of claim 15, wherein the spatial unit comprises:
a pixel;
a coding tree unit;
a macroblock; or
a frame.

17. The method of claim 14, further comprising:
transcoding the video clips at a reference bitrate and resolution into reference copies, wherein the at least the first feature set for each video clip is determined with respect to one of the reference copies.

18. The method of claim 14, wherein the visual quality metric comprises a video multi-method assessment fusion metric.

19. A non-transitory computer-readable medium storing instructions which, when executed by a processing system including at least one processor, cause the processing system to perform operations, the operations comprising:
identifying at least one feature set of at least a portion of a first video program, the at least one feature set including a complexity factor;
obtaining predicted visual qualities for candidate bitrate and resolution combinations of the at least the portion of the first video program by applying the at least one feature set to a prediction model that is trained to output the predicted visual qualities for the candidate bitrate and resolution combinations of the at least the portion of the first video program in accordance with the at least one feature set;
selecting at least one bitrate and resolution combination for at least one variant of the at least the portion of the first video program in accordance with the predicted visual qualities for the candidate bitrate and resolution combinations of the at least the portion of the first video program; and
transcoding the at least one variant of the first video program in accordance with the at least one bitrate and resolution combination that is selected for the at least one variant.

20. An apparatus comprising:
a processing system including at least one processor; and
a computer-readable medium storing instructions which, when executed by the processing system, cause the processing system to perform operations, the operations comprising:
identifying at least one feature set of at least a portion of a first video program, the at least one feature set including a complexity factor;
obtaining predicted visual qualities for candidate bitrate and resolution combinations of the at least the portion of the first video program by applying the at least one feature set to a prediction model that is trained to output the predicted visual qualities for the candidate bitrate and resolution combinations of the at least the portion of the first video program in accordance with the at least one feature set;
selecting at least one bitrate and resolution combination for at least one variant of the at least the portion of the first video program in accordance with the predicted visual qualities for the candidate bitrate and resolution combinations of the at least the portion of the first video program; and
transcoding the at least one variant of the first video program in accordance with the at least one bitrate and resolution combination that is selected for the at least one variant.
